(19) United States
(12) Patent Application Publication
(10) Pub. No.: US 2004/0051651 A1
(43) Pub. Date: Mar. 18, 2004

(54) Traffic light signal monitoring system

(76) Inventor: Greg Carter, Monroe, WA (US)

Correspondence Address: Dean A. Craine, P.S., 400 - 112th Ave. NE, Suite 140, Bellevue, WA, 98004, US

(21) Appl. No.: 10/243,891

(22) Filed: Sep. 12, 2002

(51) Int. Cl. G08G 1/095

(52) U.S. Cl. 340/907

(57) ABSTRACT

A traffic light signal monitoring system and method that enables traffic enforcement personnel to monitor the traffic moving through an intersection while positioned at a distant or remote location from the intersection where they would otherwise not be able to see the color of the traffic light signal. The system includes a distribution switch mounted in an existing traffic signal controller cabinet and electrically connected to the traffic light control circuits. The distribution switch is coupled to a radio transmitter. Connected to the transmitter is a tone generator that generates a tone when the amber light signal is activated. During use, traffic enforcement personnel positioned near the intersection are able to watch traffic travel through the intersection without looking directly at the lights activated on the traffic light. When the amber light circuit is activated, the tone is broadcast for approximately four seconds that informs the traffic enforcement personnel that the red light will be activated shortly and that their attention should be drawn to the flow of traffic through the intersection.

### BACKGROUND OF THE INVENTION

1. Field of the Invention

This invention relates to traffic light signal monitoring systems, and more particularly, to systems used by traffic enforcement personnel to determine whether drivers and pedestrians are complying with traffic laws.

2. Description of the Related Art

In many municipalities, traffic enforcement personnel routinely monitor traffic around traffic light signals for compliance with local traffic laws. In order to catch violators, traffic enforcement personnel are required to simultaneously monitor the illumination sequences of the green, amber and red lights on the traffic light signal and the movement of motor vehicles and pedestrians in the intersection. In order to issue citations to violators, the traffic enforcement personnel must know when the red light is illuminated and see the violation.

One drawback with simultaneously monitoring the illumination of the lights on the traffic light signal and the motor vehicle traffic is that the traffic enforcement personnel must be positioned near the intersection. Normally, the traffic enforcement personnel is positioned in front of or upstream from the traffic light signal so that the light signal may be seen. When a violation occurs, the traffic enforcement personnel must quickly enter or cross traffic in the intersection to pursue the violator.

Another drawback with simultaneously monitoring the illumination of the traffic light signal and the motor vehicle traffic is that other traffic infractions are missed. For example, if traffic enforcement personnel are continuously looking at the traffic light signal, he or she is unable to watch motor vehicles traveling through the intersection for other violations, such as operating a vehicle with defective equipment.

What is needed is a traffic light monitoring system that enables traffic enforcement personnel to simultaneously monitor the flow of traffic through an intersection and watch for other violators from a remote location.

### SUMMARY OF THE INVENTION

It is an object of the present invention to provide a traffic light signal monitoring system.

It is another object of the present invention to provide such a system that allows traffic enforcement personnel to simultaneously monitor the traffic light signal for violations and to watch for other violations near or around the intersection.

It is a further object of the invention to provide such a system that allows the traffic enforcement personnel to be remotely located from the intersection.

These and other objects of the present invention are met by a traffic light monitoring system that enables traffic enforcement personnel to monitor traffic light signal infractions while positioned at a distant or remote location from the intersection where they would otherwise not be able to see the color of the traffic light signal. The system, which is designed to be installed with existing traffic signal control systems, includes a distribution switch mounted inside the controller cabinet normally located adjacent to the intersection. The distribution switch is connected to the amber light circuits on each traffic light signal. During use, a traffic enforcement personnel operates the distribution switch to select the amber light circuit for a specific traffic light signal for monitoring in the intersection.

Connected to the distribution switch is a simple relay, hereinafter called a transmitter activator/isolation device, that is coupled to a wireless communication means. The transmitter activator/isolation device acts to isolate the traffic light signal circuits from the wireless communication means, and to match their voltages for activation. In the preferred embodiment, the wireless communication means is a radio transmitter designed to communicate short distances (up to 1,000 feet) with a remote radio receiver carried by the traffic enforcement personnel. During use, the transmitter activator/isolation device is activated only when the amber light circuit on the selected traffic signal light is activated. The radio transmitter is coupled to a tone generator that produces a tone that is broadcast to the remote radio receiver. No audible tone is broadcast when the light signal's red or green light circuits are activated or when the amber light circuit is off.

After the desired traffic signal light is selected, the traffic enforcement personnel positioned at a remote location near the intersection are able to watch traffic travel through the intersection without looking directly at the selected traffic signal. When the light signal's amber light circuit is activated, the audible tone is broadcast for approximately four seconds which informs the traffic enforcement personnel that his or her attention must be drawn to the traffic light signal to detect violators.

### DESCRIPTION OF THE DRAWINGS

FIG. 1 is a top plan view of a four way intersection controlled by a traffic signal controller programmed for controlling four directions.

FIG. 2 is a perspective view showing the components used in the system.

FIG. 3 is a schematic diagram of the manual switch and relay.

FIG. 4 is a block diagram view of the system.

### DESCRIPTION OF THE PREFERRED EMBODIMENT(S)

There is shown in the accompanying Figs. a traffic light monitoring system 10 and method that enables traffic enforcement personnel 90 to monitor the movement of traffic through an intersection 80 controlled by traffic signal lights 60 A-H for traffic light signal infractions while positioned at a distant location from the intersection 80 where they would otherwise not be able to see the color of a desired traffic light signal 60. During use, traffic enforcement personnel 90 are able to watch traffic travel through the intersection 80 without constantly viewing a specific traffic light signal 60. When the amber light circuit 61 on a monitored traffic light signal 60 is activated, a signal is transmitted to the traffic enforcement personnel 90 informing him to view the traffic light signal 60 and watch for violators.

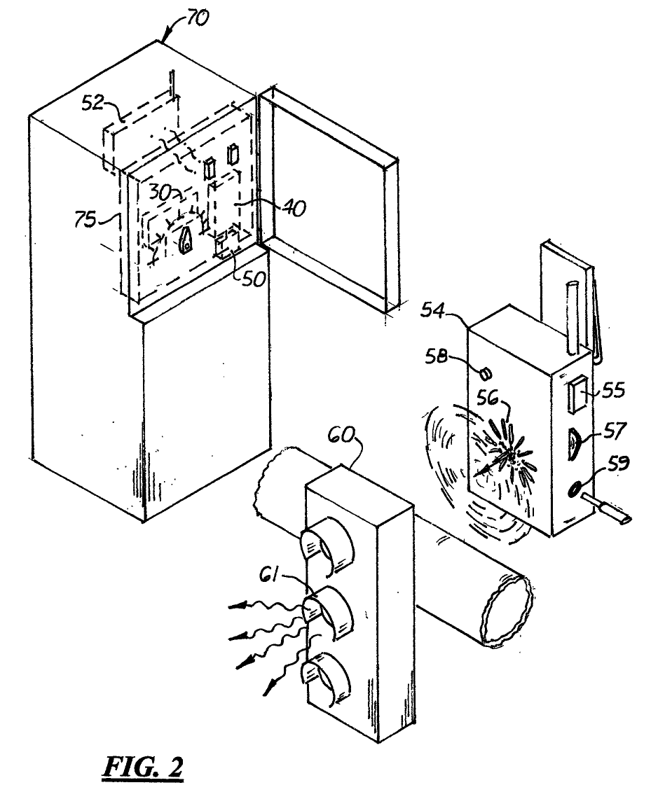

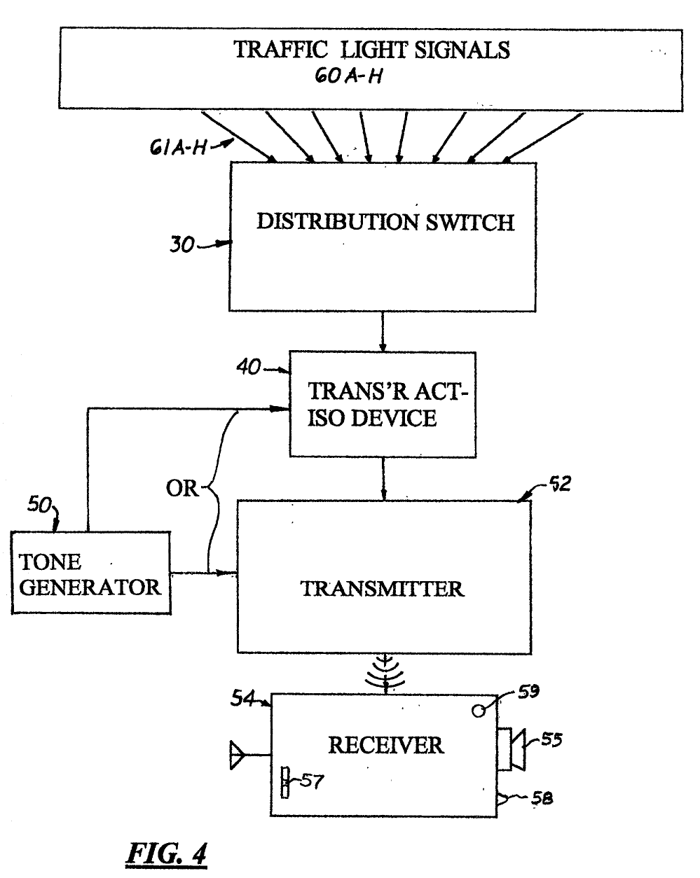

The system 10 is designed to be used with an existing traffic light control circuit 75 located in the cabinet 70 located on a curb or sidewalk 82 adjacent to the intersection 80. The system 10, shown more specifically in FIGS. 2-4, includes a distribution switch 30 connected to the amber light circuits 61 A-H for the traffic light signals 60 A-H around the intersection 80. In the preferred embodiment, the distribution switch 30 includes a turn knob 32 that enables the user to select one specific traffic light signal 60 A-H to monitor. The system 10 also includes a transmitter activation/isolation device 40 connected to the distribution switch 30 that is activated when the amber light circuit 61 A-H on a selected traffic light signal 60 A-H is activated.

The transmitter activation/isolation device 40 is connected to a wireless radio transmitter 52 capable of transmitting a radio signal for a relatively short distance to a radio receiver 54 carried by the traffic enforcement personnel 90. Coupled to the wireless radio transmitter 52 is a tone generator 50 that automatically generates a constant audible tone. The output port on the tone generator 50 is connected to the microphone's input port on the transmitter 52.

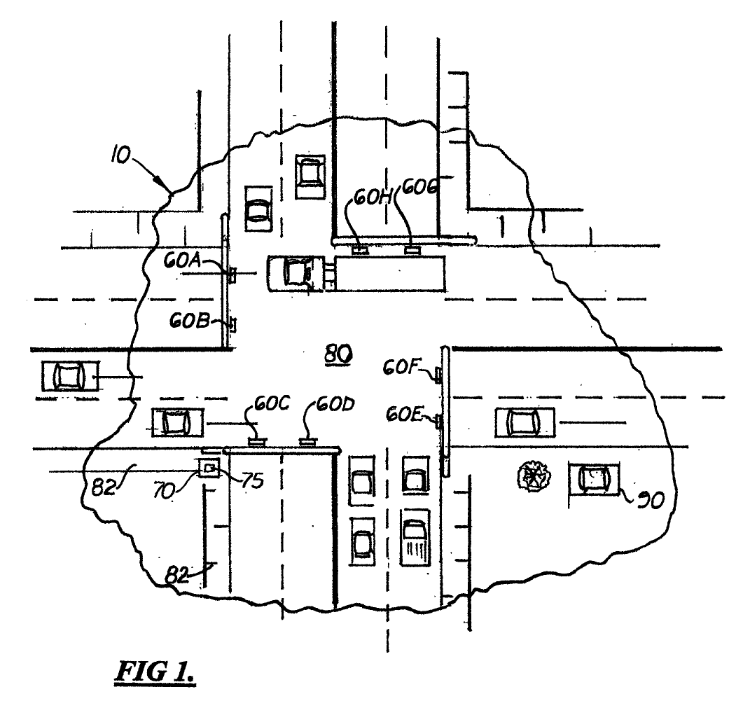

During use, traffic enforcement personnel 90 positioned at a distant or remote location near the intersection 80 are able to watch traffic travel around the intersection 80 without looking directly at the traffic light signal 60E. In FIG. 1, the traffic enforcement personnel 90 is shown located downstream from the intersection 80. When the amber light circuit 61E on the monitored traffic light signal 60E is activated, the audible tone is broadcast for approximately four seconds that informs the traffic enforcement personnel 90 that his or her attention must be drawn to the intersection 80 to watch for violations.

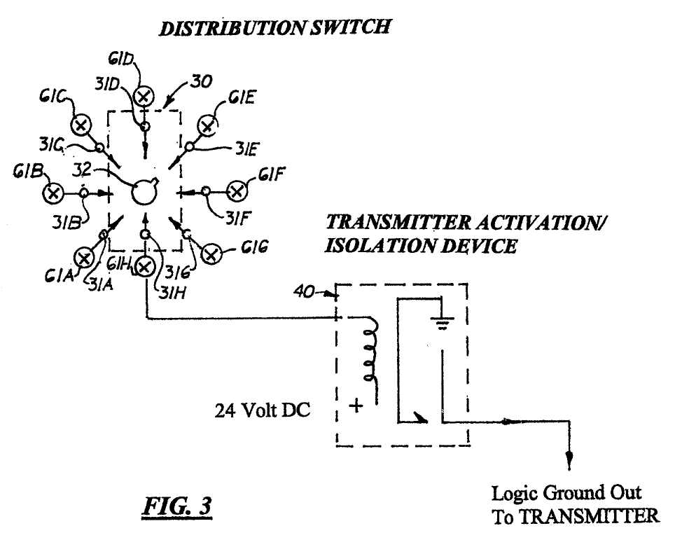

As shown in FIG. 3, the distribution switch 30 includes a plurality of input ports 31 A-H that are connected to the amber light circuits 61 A-H on the traffic light signals 60 A-H operating on the intersection 80. The distribution switch 30 includes a turn knob 32 that enables the traffic enforcement personnel 90 to manually select a particular traffic light signal 60 A-H to monitor. The tone generator 50, connected to the transmitter 52, is designed to produce a pleasant audio tone when one of the amber light circuits 61 A-H is activated.

The remote radio receiver 54 carried by the traffic enforcement personnel 90 includes an on-off switch 55, a speaker 56, a volume control 57, an optional LED light 58, and an optional ear-plug connector 59.

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A traffic light monitoring system for a traffic light signal control circuit mounted inside a controller cabinet located adjacent to an intersection, said traffic light signal control circuit including a green light, an amber light, and a red light circuit, said system comprising:
a. a distribution switch connected to at least one amber light circuit;
b. a transmitter activator/isolation device coupled to said distribution switch to isolate the circuitry of said traffic light signal;
c. a transmitter coupled to said transmitter device which is activated and transmits a signal when said amber light circuit is activated;
d. a means for producing a signal coupled to said transmitter; and,
e. a remote receiver used to receive said signal broadcast by said transmitter when said amber light circuit is activated.

2. The traffic light monitoring system, as recited in claim 1, wherein said signal means is a tone generator.

3. The traffic light monitoring system, as recited in claim 2, wherein said signal means activated continuously.

4. The traffic light monitoring system as recited in claim 1, further including a visual receiving means on said receiver that is activated when a signal from said transmitter is received.

5. The traffic light monitoring system, as recited in claim 1, further including a transmitter activation/isolation device connected between said distribution switch and said transmitter and used to convert an electrical signal from said amber light circuit into a signal useful to said transmitter.

6. The traffic light monitoring system, as recited in claim 3, wherein said visual receiving means is a light that is illuminated when said signal from said receiver is received.
